(19) United States
(12) Patent Application Publication
(10) Pub. No.: US 2015/0155810 A1
(43) Pub. Date: Jun. 4, 2015

(54) ROTARY ELECTRIC MACHINE CONTROL SYSTEM AND ROTARY ELECTRIC MACHINE CONTROL METHOD

(71) Applicant: TOYOTA JIDOSHA KABUSHIKI KAISHA, Toyota-shi, Aichi-ken (JP)

(72) Inventors: Eiji Yamada, Owariasahi-shi (JP); Kenji Hiramoto, Owariasahi-shi (JP)

(73) Assignee: TOYOTA JIDOSHA KABUSHIKI KAISHA, Toyota-shi, Aichi-ken (JP)

(21) Appl. No.: 14/412,282

(22) PCT Filed: Sep. 24, 2013
(86) PCT No.: PCT/IB2013/002210

§ 371 Date: Dec. 31, 2014

(30) Foreign Application Priority Data
Oct. 9, 2012 (JP) 2012-224373

(51) Int. Cl. H02P 21/00; H02P 21/14

(52) U.S. Cl. CPC H02P 21/0035; H02P 21/148

(57) ABSTRACT

A rotary electric machine control system includes a control device that controls a rotary electric machine. When there is a current phase at which a reluctance torque is maximum between a first current phase (θ1) of a first current vector (I₁) on which current pulses have not been superimposed yet and a second current phase (θ2) of a second current vector (I₂) obtained by increasing a d-axis current and reducing a q-axis current, the control device sets an intermediate current vector (Im) having an intermediate phase (θm) between the first and second current phases (θ1, θ2). The intermediate current vector (Im) is set so as to be larger than an imaginary current vector (Ima) at the intermediate phase (θm) in the case where a vector locus is varied in a straight line from the first current vector (I₁) to the second current vector (I₂). The current pulses are generated by changing the current vector in order of I₁, Im and I₂ and returning the current vector in order of Im and I₁.

### BACKGROUND OF THE INVENTION

1. Field of the Invention

The invention relates to a rotary electric machine control system and a rotary electric machine control method and, more particularly, to control in the case where current pulses are superimposed on a current vector.

2. Description of Related Art

Japanese Patent Application Publication No. 2011-41433 (JP 2011-41433 A) describes a control device for an electromagnet rotary electric machine. The rotary electric machine includes a stator that generates a revolving magnetic field and a rotor that faces the stator and rotates. The rotor includes rotor coils and diodes respectively short-circuited with the rotor coils in selected polarities. In the control device, current pulses are superimposed on the stator currents respectively flowing through the stator coils when a predetermined condition is satisfied.

In the rotary electric machine described in JP 2011-41433 A, it is conceivable as a method of superimposing current pulses on the stator currents that a d-axis pulse that increases and then reduces is superimposed on a d-axis current of the current vector that generates a revolving magnetic field and a q-axis pulse that reduces and then increases is superimposed on a q-axis current of the current vector. With this configuration, it is possible to improve rotor torque, on which the current pulses have been superimposed, without excessively increasing the stator currents at the time of superimposing the current pulses; however, there is still room for improvement in terms of improving rotor torque at the time when the current pulses are being superimposed.

### SUMMARY OF THE INVENTION

A rotary electric machine control system and a rotary electric machine control method according to the invention are able to improve rotor torque at the time when current pulses are being superimposed on a current vector that generates a revolving magnetic field.

A first aspect of the invention provides a rotary electric machine control system. The rotary electric machine control system includes: a rotary electric machine including a stator configured to generate a revolving magnetic field; a rotor arranged so as to face the stator, the rotor having rotor coils wound around rotor cores through rotor slots, the rotor having rectifying units connected to the corresponding rotor coils and each configured to rectify a rotor coil current in a selected, one direction, and the rotor having rotor salient poles that have alternately different polarities in a circumferential direction due to the rotor coil currents; and a control device configured to superimpose current pulses on a current vector that generates the revolving magnetic field, the control device being configured to set a first current vector on which the current pulses have not been superimposed yet and a second current vector obtained by increasing a d-axis current by a predetermined amount of increase and reducing a q-axis current by a predetermined amount of reduction from the first current vector, the control device being configured to, where a phase between the current vector and a d-axis positive direction is defined as a current phase, set an intermediate current vector when there is a current phase at which a reluctance torque is maximum between a first current phase of the first current vector and a second current phase of the second current vector, the intermediate current vector having an intermediate phase between the first current phase and the second current phase and being larger than an imaginary current vector in the case where a vector locus is varied in a straight line from the first current vector to the second current vector, the control device being configured to change the current vector from the first current vector to the second current vector and further change the current vector from the second current vector to the first current vector, and the control device being configured to generate the current pulses by changing the current vector to the intermediate current vector in at least one of the time when the current vector is being changed from the first current vector to the second current vector and the time when the current vector is being changed from the second current vector to the first current vector.

In the above rotary electric machine control system, the control device may be configured to set an end point of the first current vector and an end point of the second current vector on a common current control circle, and the control device may be configured to set an end point of the intermediate current vector in a region surrounded by the current control circle and an imaginary vector locus that varies in a straight line from the first current vector to the second current vector, the region including the current control circle other than the end point of the first current vector and the end point of the second current vector.

In the above rotary electric machine control system, the intermediate current vector may have the current phase at which the reluctance torque is maximum, and the control device may be configured to set the end point of the intermediate current vector on the current control circle.

In the rotary electric machine control system according to the first aspect of the invention, the control device may be configured to set an end point of the first current vector on a first current control circle, the control device may be configured to set an end point of the second current vector on a second current control circle larger than the first current control circle, and the control device may be configured to set an end point of the intermediate current vector in a region surrounded by an imaginary vector locus that varies in a straight line from the first current vector to the second current vector, the second current control circle, and a line that connects the end point of the first current vector to a point on the second current control circle located on a q-axis positive direction side with respect to the end point of the first current vector, the region including the second current control circle.

In the above rotary electric machine control system, the intermediate current vector may have the current phase at which the reluctance torque is maximum, and the control device may be configured to set the end point of the intermediate current vector on the second current control circle.

A second aspect of the invention provides a control method for a rotary electric machine. The rotary electric machine includes a stator configured to generate a revolving magnetic field and a rotor arranged so as to face the stator, the rotor having rotor coils wound around rotor cores through rotor slots, the rotor having rectifying units connected to the corresponding rotor coils and each configured to rectify a rotor coil current in a selected one direction, and the rotor having rotor salient poles that have alternately different polarities in a circumferential direction due to the rotor coil currents. The control method includes: superimposing current pulses on a current vector that generates the revolving magnetic field; setting a first current vector on which the current pulses have not been superimposed yet and a second current vector obtained by increasing a d-axis current by a predetermined amount of increase and reducing a q-axis current by a predetermined amount of reduction from the first current vector; where a phase between the current vector and a d-axis positive direction is defined as a current phase, setting an intermediate current vector when there is a current phase at which a reluctance torque is maximum between a first current phase of the first current vector and a second current phase of the second current vector, the intermediate current vector having an intermediate phase between the first current phase and the second current phase and being larger than an imaginary current vector in the case where a vector locus is varied in a straight line from the first current vector to the second current vector; changing the current vector from the first current vector to the second current vector and further changing the current vector from the second current vector to the first current vector; and generating the current pulses by changing the current vector to the intermediate current vector in at least one of the time when the current vector is being changed from the first current vector to the second current vector and the time when the current vector is being changed from the second current vector to the first current vector.

With the rotary electric machine control system and the control method according to the aspects of the invention, the reluctance torque increases by changing the current vector to the intermediate current vector at the time when the current pulses are being superimposed on the current vector that generates the revolving magnetic field. Therefore, the rotor torque at the time when the current pulses are being superimposed is improved.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a view that shows the partially cross-sectional view of a rotary electric machine in a circumferential direction and the configuration of a rotary electric machine drive unit in a rotary electric machine control system according to an embodiment of the invention;

FIG. 2 is a functional block diagram of a control device shown in FIG. 1;

FIG. 3 is a graph that shows a variation in current vector when current pulses are superimposed using a d-q coordinate system in the embodiment of the invention;

FIG. 4 is a time chart that shows an example of time changes in d-axis current Id, q-axis current Iq and rotor torque Tr when current pulses are superimposed in the embodiment of the invention;

FIG. 5 is a partially schematic view of the rotary electric machine in the circumferential direction when a rotor salient pole is shifted from one stator salient pole by a phase at which a reluctance torque is maximum;

FIG. 6 is a graph that shows the correlation between a reluctance torque of the rotary electric machine and a current phase of the current vector in the embodiment of the invention;

FIG. 7 is a graph corresponding to FIG. 3 in an alternative embodiment of the invention;

FIG. 8 is a time chart corresponding to FIG. 4 in the alternative embodiment of the invention; and

FIG. 9 is a circuit implementation diagram that partially shows a rotor in a circumferential direction in a state where diodes are connected to rotor coils in an alternative embodiment of a rotary electric machine.

### DETAILED DESCRIPTION OF EMBODIMENTS

Hereinafter, an embodiment of the invention will be described with reference to the accompanying drawings. In the following description, a rotary electric machine functions as a motor generator, and is used as a drive source of a hybrid vehicle. This is only illustrative, and the rotary electric machine may be used as a drive source of another electromotive vehicle, such as an electric vehicle. In addition, the rotary electric machine may function as merely an electric motor or merely a generator. In addition, like reference numerals denote similar elements in all the drawings.

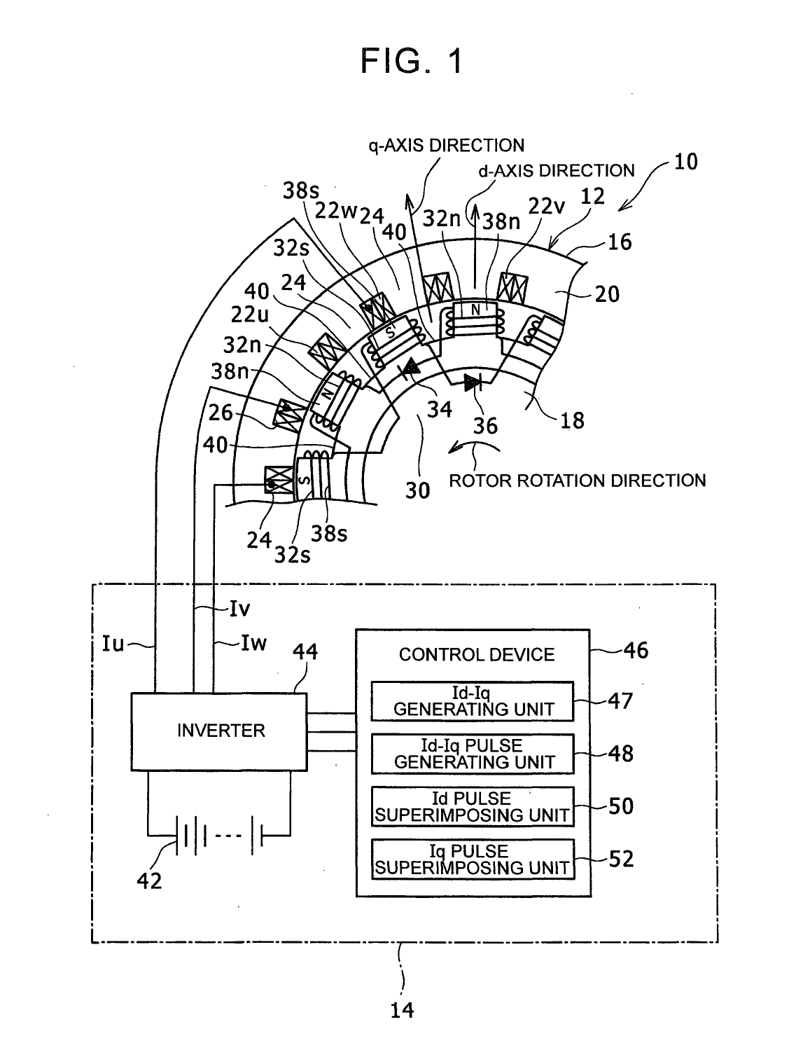

FIG. 1 is a view that shows a rotary electric machine control system 10 according to the present embodiment, and is a view that shows the partially cross-sectional view of a rotary electric machine 12 in the circumferential direction and the configuration of a rotary electric machine drive unit 14. The rotary electric machine control system 10 includes the rotary electric machine 12 and the rotary electric machine drive unit 14. The rotary electric machine 12 has the function of a motor generator having the function of a motor that drives drive wheels of a hybrid vehicle (not shown) and the function of a generator that generates electric power through regenerative braking of the drive wheels.

The rotary electric machine 12 includes a stator 16 and a rotor 18. The stator 16 is fixed to a case (not shown). The rotor 18 is arranged so as to face the stator 16, and rotates. The stator 16 includes a stator core 20 and three u-phase, v-phase and w-phase stator coils 22u, 22v, 22w wound around salient poles of the stator core 20. The stator core 20 is formed of a magnetic material, such as a laminate of metal sheets, such as magnetic steel sheets. The stator core 20 has a plurality of stator salient poles 24 and slots 26. The plurality of stator salient poles 24 are provided at equal intervals in the circumferential direction so as to protrude radially inward toward the rotor 18. Each of the slots 26 is formed between any adjacent two of the stator salient poles 24. A “radial direction” indicates a radial direction perpendicular to the rotation central axis of the rotor 18. A “circumferential direction” indicates a rotor circumferential direction about the rotation central axis of the rotor 18. An “axial direction” indicates the axial direction of the rotor 18.

The stator coils 22u, 22v, 22w are respectively wound around the stator salient poles 24 through the slots 26 by concentrated winding. When three-phase stator currents respectively flow through the stator coils 22u, 22v, 22w, the stator salient poles 24 are magnetized, and a revolving magnetic field is generated in the stator 16.

The stator coils may be wound by toroidal winding by which multiple-phase stator coils are wound at multiple locations of an annular portion of the stator core 20 in the circumferential direction.

The rotor 18 is arranged at a predetermined clearance on the radially inward of the stator 16 so as to face the stator 16, and is rotatable with respect to the stator 16. A rotary shaft supported by a bearing of the case (not shown) is fixedly inserted in a central axis hole of the rotor 18. The rotor 18 includes a rotor core 30, a plurality of rotor coils 32n; 32s wound around the rotor cores 30, and diodes 34, 36 that serve as rectifying units.

The rotor core 30 is formed of a magnetic material, such as a laminate of metal sheets, such as magnetic steel sheets, and has rotor salient poles 38n, 38s that are magnetic pole portions provided at the outer peripheral side at multiple locations at equal intervals in the circumferential direction. The rotor salient poles 38n are magnetized to N pole by a rotor coil current that flows through the rotor coils 32n (described later). The rotor salient poles 38s are magnetized to S pole by a rotor coil current that flows through the rotor coils 32s (described later). The rotor salient poles 38n and the rotor salient poles 38s are arranged alternately in the circumferential direction. A groove-shaped slot 40 is formed between any adjacent rotor salient poles 38n, 38s on the outer periphery of the rotor core 30. The slots 40 form space in which the rotor coils 32n, 32s are arranged.

The rotor coils 32n, 32s consist of the rotor coils 32n and the rotor coils 32s. The rotor coils 32n are wound by concentrated winding through the slots 40 around the rotor salient poles 38n that are every other salient poles of the rotor 18 in the circumferential direction. The rotor coils 32s are wound by concentrated winding through the slots 40 around the rotor salient poles 38s that are every other salient poles of the rotor 18 in the circumferential direction and adjacent to the rotor salient poles 38n. The rotor coils 32n that are every other rotor coils in the circumferential direction are serially connected to each other, and are connected to the first diode 34 so as to be short-circuited in one direction. In addition, the rotor coils 32s that are different every other rotor coils in the circumferential direction are also serially connected to each other, and are connected to the second diode 36 so as to be short-circuited in the other direction.

It is also applicable that all the rotor coils 32n, 32s are separated, the rotor coils 32n are respectively connected to first diodes so as to be short-circuited in one direction, and the rotor coils 32s are respectively connected to second diodes so as to be short-circuited in the other direction. In addition, each of the rotor coils 32n, 32s may be wound by regular winding by which each of the rotor coils 32n, 32s is wound around a corresponding one of the rotor salient poles 38n, 38s in multiple rows and multiple layers.

With this configuration, when magnetic fluxes link with the rotor coils 32n, 32s from the stator 16 side and then rotor coil currents that are induced currents flow in response to variations in stator currents as will be described later, the rotor coil currents are respectively rectified by the diodes 34, 36 in one direction and the other direction, and the rotor salient poles 38n, 38s are magnetized to desired polarities. Each rotor coil 32n forms N pole at the distal end of the corresponding rotor salient pole 38n in accordance with the rectifying direction of the first diode 34. Each rotor coil 32s forms S pole at the distal end of the corresponding rotor salient pole 38s in accordance with the rectifying direction of the second diode 36. The rotor salient poles 38n, 38s are arranged alternately in the circumferential direction, so the rotor salient poles 38n, 38s are respectively magnetized by the corresponding rotor coil currents to N pole and S pole that are polarities alternately different in the circumferential direction.

The configuration of the rotary electric machine 12 is described above. Next, the rotary electric machine drive unit 14 will be described. The rotary electric machine drive unit 14 includes an electrical storage unit 42, an inverter 44 and a control device 46. The electrical storage unit 42 is provided as a direct-current power supply, and is formed of a secondary battery. The inverter 44 includes a plurality of switching elements, such as transistors and IGBTs. The inverter 44 converts direct-current power from the electrical storage unit 42 to u-phase, v-phase and w-phase alternating-current powers through switching operations of the switching elements, and then supplies the u-phase, v-phase and w-phase alternating-current powers to the corresponding three-phase stator coils 22u, 22v, 22w. A step-up device that steps up the voltage of the electrical storage unit 42 and then outputs the stepped-up voltage to the inverter 44 may be provided between the electrical storage unit 42 and the inverter 44.

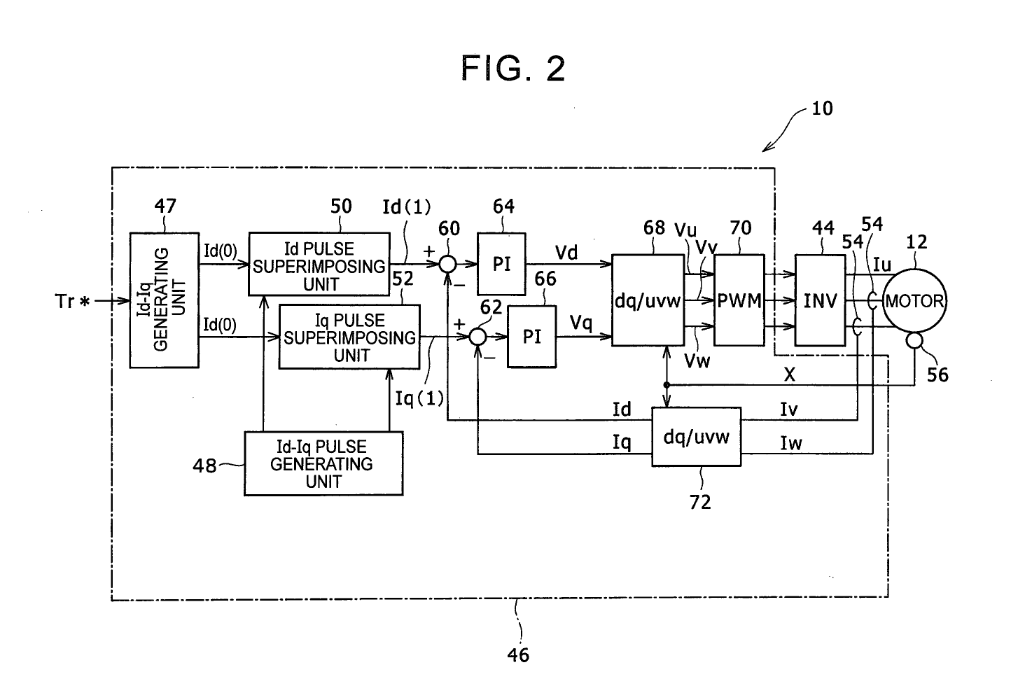

The control device 46 includes a microcomputer that has a CPU, a memory, and the like, and executes drive control over the rotary electric machine 12 by controlling switching operations of the switching elements of the inverter 44. The control device 46 may be integrated with the rotary electric machine 12 or may be arranged separately from the rotary electric machine 12 on a vehicle body, or the like. The control device 46 includes an Id-Iq generating unit 47, an Id-Iq pulse generating unit 48, an Id pulse superimposing unit 50 and an Iq pulse superimposing unit 52. This will be described in detail with reference to FIG. 2.

FIG. 2 shows functional blocks of the control device 46 shown in FIG. 1, a current sensor 54 and a rotation sensor 56. The current sensor 54 detects stator currents Iv, Iw respectively flowing through the v-phase stator coils and w-phase stator coils of the rotary electric machine 12, and transmits the detected stator currents to the control device 46. It is possible to calculate a stator current Iu flowing through the u-phase stator coils on the basis of the detected stator currents Iv, Iw; instead, the stator current Iu may be detected by another current sensor.

The rotation sensor 56 detects a rotation angle x of the rotary electric machine 12, and then transmits the detected rotation angle x to the control device 46. The rotation sensor 56 is formed of a resolver, or the like. In addition, a torque command value Tr* that is a target torque based on a driver's operation amount of an accelerator pedal is input to the control device 46.

The control device 46 executes drive control over the rotary electric machine 12 by controlling the stator currents through d-q axis vector current control. The control device 46 includes the Id-Iq generating unit 47, the Id pulse superimposing unit 50, the Iq pulse superimposing unit 52, subtracters 60, 62, PI control units 64, 66, a two-phase/three-phase conversion unit 68, a PWM generating unit 70 and a three-phase/two-phase conversion unit 72. The Id-Iq generating unit 47 serves as a current command generating unit.

The torque command value Tr* is input to the Id-Iq generating unit 47. The Id-Iq generating unit 47 generates a d-axis current command value Id(0) and q-axis current command value Iq(0) of the current vector on the basis of the torque command value Tr*. The current vector causes the stator 16 to generate a revolving magnetic field. Here, the d axis means a magnetic pole direction that is the winding central axis direction of each of the rotor coils 32n, 32s in the circumferential direction of the rotary electric machine 12, and the q axis means a direction advanced by 90 degrees in electric angle with respect to the d axis. For example, when the rotation direction of the rotor 18 is defined as shown in FIG. 1, the d-axis direction and the q-axis direction are defined by the relationship as indicated by the arrows in FIG. 1.

The d-axis current command value Id(0) generated by the Id-Iq generating unit 47 is output to the Id pulse superimposing unit 50, and the q-axis current command value Iq(0) generated by the Id-Iq generating unit 47 is output to the Iq pulse superimposing unit 52. In the Id-Iq generating unit 47, the d-axis current command value Id(0) and the q-axis current command value Iq(0) may be generated on the basis of a motor rotation speed calculated from the detected rotation angle x, the electrical storage unit 42-side voltage of the inverter 44, detected by a voltage sensor (not shown), and the torque command value Tr*.

A variation in Id pulse generated by the Id-Iq pulse generating unit 48 is input to the Id pulse superimposing unit 50. The Id pulse superimposing unit 50 superimposes the variation in Id pulse on the d-axis current command value Id(0) at predetermined timing, and then outputs the changed d-axis current command value Id(1) to the subtracter 60.

A variation amount in Iq pulse generated by the Id-Iq pulse generating unit 48 is input to the Iq pulse superimposing unit 52. The Iq pulse superimposing unit 52 superimposes the variation in Iq pulse on the q-axis current command value Iq(0) at predetermined timing, and then outputs the changed q-axis current command value Iq(1) to the subtracter 62. The Id-Iq pulse generating unit 48 will be described in detail later.

A current value Id is input from the three-phase/two-phase conversion unit 72 to the subtracter 60. The subtracter 60 calculates a deviation between the changed d-axis current command value Id(1) and the current value Id, and then outputs the calculated deviation to the PI control unit 64.

A current value Iq is input from the three-phase/two-phase conversion unit 72 to the subtracter 62. The subtracter 62 calculates a deviation between the changed q-axis current command value Iq(1) and the current value Iq, and then outputs the calculated deviation to the PI control unit 66.

The PI control units 64, 66 respectively calculate a d-axis voltage Vd and a q-axis voltage Vq by executing PI control over the input deviations on the basis of a preset PI gain, and then output the calculated d-axis voltage Vd and the calculated q-axis voltage Vq to the two-phase/three-phase conversion unit 68.

The two-phase/three-phase conversion unit 68 calculates three-phase voltages Vu, Vv, Vw by performing two-phase/three-phase conversion on the basis of the input d-axis voltage Vd and q-axis voltage Vq and the rotation angle x received from the rotation sensor 56, and then outputs the three-phase voltages Vu, Vv, Vw to the PWM generating unit 70.

The PWM generating unit 70 generates switching control signals for turning on or off the upper and lower switching elements of each phase of the inverter 44 through voltage comparison between the three-phase voltages Vu, Vv, Vw and a prestored carrier wave, and then outputs the switching control signals to the inverter 44. The inverter 44 turns on or off the switching elements of the inverter 44 on the basis of the corresponding switching control signals. Thus, the stator currents Iu, Iv, Iw flow through the three-phase stator coils of the rotary electric machine 12.

The stator currents Iv, Iw are input from the current sensor 54 to the three-phase/two-phase conversion unit 72. The three-phase/two-phase conversion unit 72 calculates a d-axis current Id and a q-axis current Iq by performing three-phase/two-phase conversion on the basis of the stator currents Iv, Iw and the rotation angle x received from the rotation sensor 56, and then outputs the d-axis current Id and the q-axis current Iq to the subtracters 60, 62, respectively. In the control device 46, feedback control is executed such that the d-axis and q-axis current values Id, Iq respectively coincide with the changed d-axis current command value Id(1) and the changed q-axis current command value Iq(1).

Here, the Id-Iq pulse generating unit 48 will be described. The Id-Iq pulse generating unit 48 generates a plurality of variation amounts that constitute the Id pulse to be superimposed on the d-axis current command value Id(0) separately in multiple control cycles, and generates a plurality of variation amounts that constitute the Iq pulse to be superimposed on the q-axis current command value Iq(0) separately in multiple control cycles.

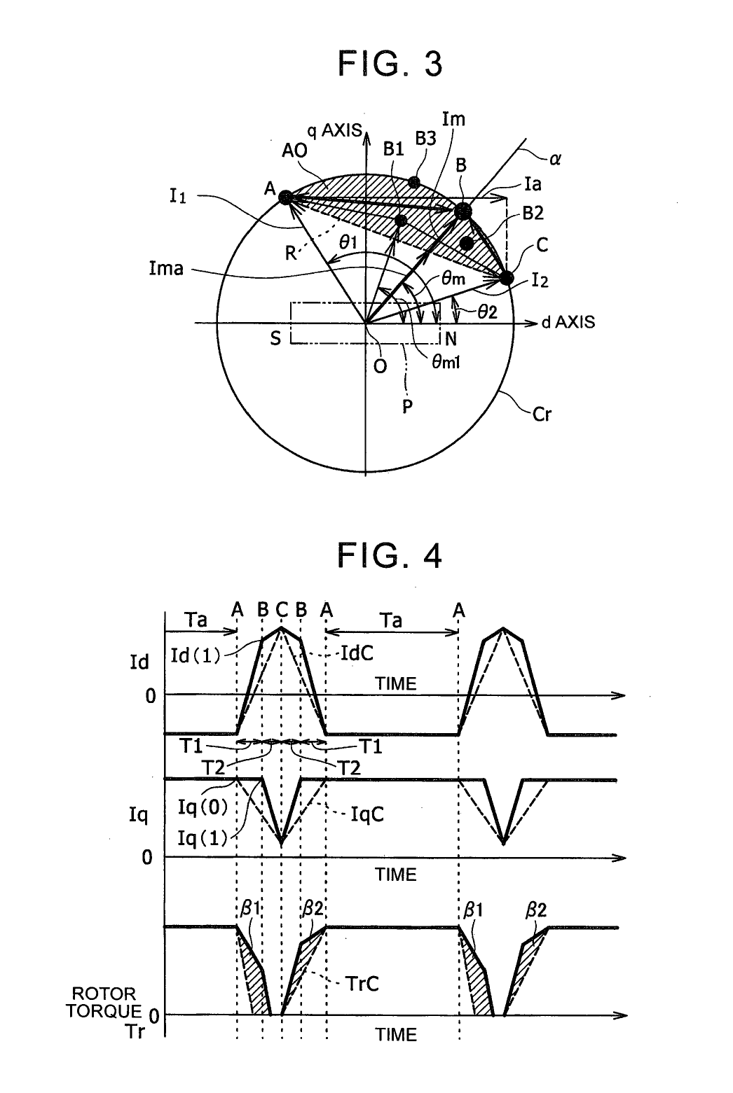

FIG. 3 shows a variation in current vector when the current pulses are superimposed using a d-q coordinate system. The alternate long and two short dashed line P in FIG. 3 conceptually indicates an electromagnet that is formed by each of the rotor coils 32n, 32s.

The Id-Iq pulse generating unit 48 sets a first current vector I₁ on which current pulses have not been superimposed yet and a second current vector I₂ on which the current pulses have been superimposed. The second current vector I₂ is set by increasing the d-axis current Id by a predetermined amount of increase and reducing the q-axis current Iq by a predetermined amount of reduction from the first current vector I₁. Where a phase between a current vector and a d-axis positive direction is defined as a current phase, there is a current phase θm of 45° at which a reluctance torque is maximum between a first current phase θ1 of the first current vector I₁ and a second current phase θ2 of the second current vector I₂.

At this time, the Id-Iq pulse generating unit 48 sets an intermediate current vector Im having the current phase θm as an intermediate phase between the first current phase θ1 and the second current phase θ2. The intermediate current vector Im is larger than an imaginary current vector Ima at the intermediate phase θm when a vector locus is varied in a straight line from the first current vector I₁ to the second current vector I₂.

The Id-Iq pulse generating unit 48 changes the current vector from the first current vector I₁ to the second current vector I₂, and further returns the current vector from the second current vector I₂ to the first current vector I₁. In this case, the Id-Iq pulse generating unit 48 generates the Id pulse and the Iq pulse by changing the current vector to the intermediate current vector Im both at the time when the current vector is changed from the first current vector I₁ to the second current vector I₂ and at the time when the current vector is changed from the second current vector I₂ to the first current vector I₁.

End points A, B, C of the current vectors I₁, Im, I₂ all are set on a common current control circle Cr. Starting points of the current vectors I₁, Im, I₂ are at an origin point O. The end point B of the intermediate current vector Im is set on the current control circle Cr at the intersection of the current control circle Cr with a maximum reluctance torque phase line α at a current phase of θm.

The end point of the current vector starts from point A at the time when superimposition of the current pulses is started, reaches point B after a lapse of a preset first predetermined period of time T1, then reaches point C after a lapse of a second predetermined period of time T2, and sequentially returns to point B in the same second predetermined period of time T2 and then to point A in the same first predetermined period of time T1. That is, the end point of the current vector changes in order of A, B, C, B and A. A vector locus between the current vectors I₁, Im, I₂ becomes a straight line between A and B and between B and C. The first predetermined period of time T1 at the time when the current vector is changed between the first current vector I₁ and the intermediate current vector Im is desirably set so as to be shorter than or equal to the second predetermined period of time T2 at the time when the current vector is changed between the intermediate current vector Im and the second current vector I₂ (T1≦T2). More desirably, T1<T2. The size of the current control circle Cr is determined on the basis of an allowable current that is required by a component, such as the inverter 44.

The variation amounts of the d-axis current Id and q-axis current Iq in the current vectors I₁, Im, I₂ are separated in multiple control cycles, and output from the Id-Iq pulse generating unit 48 to the Id pulse superimposing unit 50 and the Iq pulse superimposing unit 52. Then, the variation amounts are superimposed on the pre-changed d-axis current command value Id(0) and the pre-changed q-axis current command value Iq(0), and output to the subtracters 60, 62. Therefore, as shown in the time change of the d-axis current Id at the upper side in FIG. 4, the Id pulse is superimposed on the d-axis current Id. The Id pulse steeply increases from the end of a non-superimposed period Ta, corresponding to point A, and steeply reduces from point C as an upper limit. FIG. 4 shows the case where the rotor 18 rotates at a constant speed.

In addition, as shown in the time change of the q-axis current Iq at the middle of FIG. 4, the q-axis current Iq is superimposed on the q-axis current Iq. The q-axis current Iq does not change much between point A and point B, but the Iq pulse that steeply reduces from point B and steeply increases from point C as a lower limit. Such superimposition of the Id pulse and the Iq pulse is performed at preset predetermined timing in one electric cycle.

Next, the operation of the rotary electric machine 12 and the function effect of the rotary electric machine control system 10 will be described sequentially. As three-phase alternating currents respectively flow through the three-phase stator coils 22u, 22v, 22w shown in FIG. 1, a revolving magnetic field is formed in the stator 16. The revolving magnetic field includes not only a sinusoidal distribution but also harmonic components as a magnetomotive force distribution. Particularly, in concentrated winding, the three-phase stator coils 22u, 22v, 22w do not overlap with one another in the radial direction, so the amplitude level of the harmonic components included in the magnetomotive force distribution of the stator 16 increases. For example, in the case of three-phase concentrated winding, the amplitude level of a temporally third-order and spatially second-order harmonic component of the frequency of input current of each of the stator coils 22u, 22v, 22w increases in the harmonic components. Such harmonic components are called space harmonics. Here, when the fundamental component of the revolving magnetic field acts on the rotor 18, the rotor salient poles 38n, 38s are attracted toward the stator salient poles 24 such that magnetic resistance between the stator 16 and the rotor 18 reduces. Thus, a reluctance torque acts on the rotor 18.

When the revolving magnetic field acts from the stator 16 on the rotor 18, flux leakage that leaks from the stator 16 into the slots 40 of the rotor 18 occurs due to flux fluctuations in harmonic components included in the revolving magnetic field, and the flux leakage fluctuates. When fluctuations in flux leakage are large, a rotor coil current is generated in at least one of the rotor coils 32n, 32s arranged in each slot 40. As the rotor coil current is generated, the rotor coil current is rectified by the diode 34 or the diode 36, and flows in a predetermined one direction. The rotor salient pole 38n is magnetized as the current rectified by the diode 34 flows through the corresponding rotor coil 32n, and the rotor salient pole 38s is magnetized as the current rectified by the diode 36 flows through the corresponding rotor coil 32s, so the rotor salient poles 38n, 38s function as magnetic poles having desired polarities. In this case, due to the difference in the rectifying direction between the diodes 34, 36, N pole and S pole are alternately arranged in the circumferential direction as the magnetic poles that are generated by the rotor coil currents.

In the rotary electric machine 12, the magnitudes of the rotor coil currents are determined on the basis of the stator currents Iu, Iv, Iw and the rotor rotation speed, and the rotor coil currents increase as the rotor rotation speed increases in a range lower than or equal to a certain rotation speed. In this case, the rotor torque also increases with the rotor coil currents.

On the other hand, different from the present embodiment, when no current pulses are superimposed on the d-axis current command value Id(0) and the q-axis current command value Iq(0), the fluctuation frequency of flux leakage that links from the stator 16 with the rotor coils 32n, 32s is low in a low rotation speed region of the rotor 18, so the rotor coil currents reduce, and the rotor torque also reduces. In the present embodiment, the Iq pulse is superimposed on the q-axis current command value Iq(0) as shown in FIG. 3 and FIG. 4, so it is possible to increase fluctuations in flux leakage that leaks from the stator 16 into the slots 40 of the rotor 18, with the result that the rotor coil currents increase. Moreover, the Id pulse is superimposed on the d-axis current command value Id(0), so fluctuations in magnetic fluxes that pass through a d-axis magnetic path generated in the d-axis direction between the rotor 18 and the stator 16 in FIG. 1 increase. The rotor coil currents flow through the rotor coils 32n, 32s so as to interfere with the fluctuations. Therefore, the rotor coil currents further increase. Thus, it is possible to increase the rotor torque in the low rotation speed region.

Moreover, the Id pulse that varies in the opposite direction with respect to the Iq pulse is superimposed on the d-axis current command value Id(0), and the end points A, B, C of the current vectors I₁, Im, I₂ all are located on the same current control circle Cr. Therefore, it is possible to cause the stator currents, defined by the current vectors I₁, Im, I₂, to fall within the current control circle Cr within which the current vector I₁ on which the current pulses have not been superimposed yet falls. On the other hand, a current vector Ia is a current vector according to a comparative embodiment in which only the Id pulse is superimposed on the d-axis current Id and no Iq pulse is superimposed on the q-axis current Iq. It is understandable that the current vector Ia falls outside the current control circle Cr and the stator currents exceed a current limit range.

Furthermore, at the time when the current pulses are being superimposed on the current vector that generates a revolving magnetic field, the control device 46 changes the current vector to the intermediate current vector Im of which the current phase is the intermediate phase, that is, 45°, and increases the intermediate current vector Im as compared to the imaginary current vector Ima at the intermediate phase θm in the case where a vector locus is varied in a straight line from the first current vector I₁ to the second current vector I₂, so it is possible to improve the rotor torque at the time when the current pulses are being superimposed. This will be described with reference to FIG. 3 to FIG. 5.

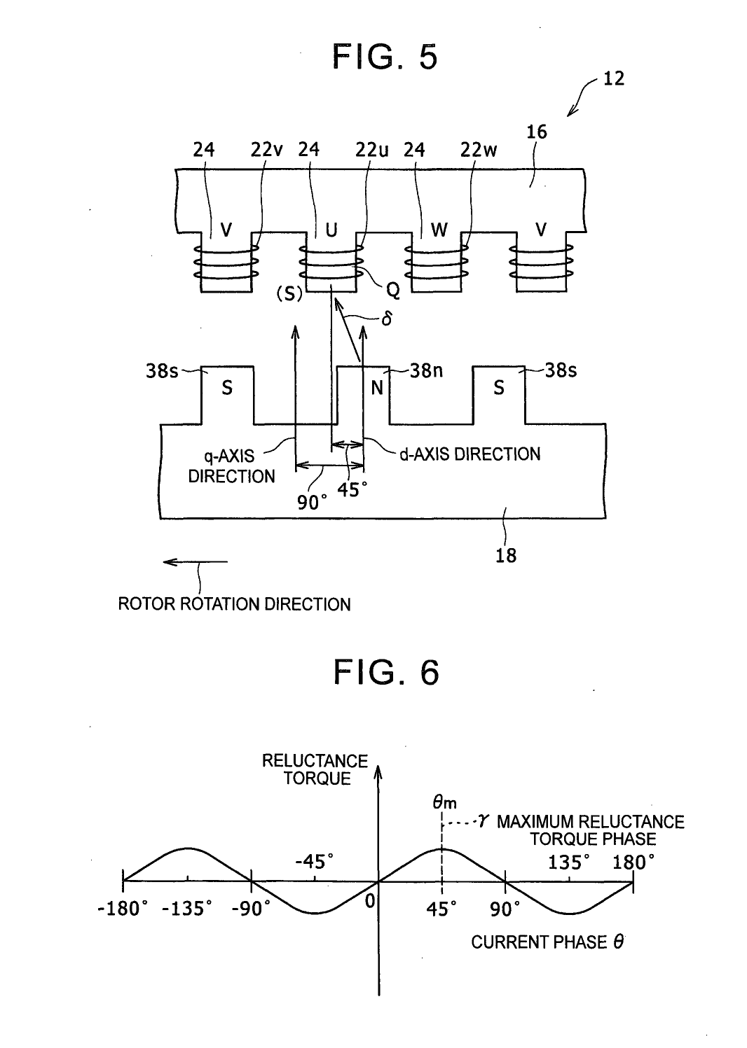

FIG. 5 is a partially schematic view of the rotary electric machine 12 in the circumferential direction, and one of the rotor salient poles 38n is shifted from one stator salient pole 24 at a Q position by the phase of 45°. Here, the “phase” indicates the electric angle of the rotor 18 in the case where the angle between the center of N pole and the center′ of S pole in the rotor 18 is 180°, and differs from the “current phase” described above. The above one stator salient pole 24 is located forward of the rotor salient pole 38n in the rotation direction. This corresponds to the case where the end point of the current vector is located on the maximum reluctance torque phase line α in FIG. 3.

FIG. 6 shows the correlation between a reluctance torque of the rotary electric machine 12 and a current phase θ of the current vector in the present embodiment. In FIG. 6, the dashed line γ corresponds to the intermediate phase θm of the intermediate current vector Im of which the end point of the current vector is set on the maximum reluctance torque phase line α in FIG. 3, and the reluctance torque is maximum at the intermediate phase θm.

In this case, the intermediate current vector Im is larger than the imaginary current vector Ima at the intermediate phase θm, so it is possible to increase the magnetic force of each stator salient pole 24 in the case where the reluctance torque is maximum. Therefore, as shown in FIG. 5, it is possible to increase the reluctance torque by increasing magnetic attraction that acts in an arrow 8 direction between the rotor salient pole 38n and the stator salient pole 24. In this way, the rotor torque at the time when the current pulses are being superimposed is improved by changing the current vector to the intermediate current vector Im at the time when the current pulses are being superimposed on the current vector.

The end point B of the intermediate current vector Im is set on the same current control circle Cr on which the end point A of the first current vector I₁ and the end point C of the second current vector I₂ are located, so it is possible to keep the stator currents at the time when the current pulses are being superimposed at the same magnitude as the stator currents on which the current pulses have not been superimposed yet, and it is possible to effectively protect the component, such as the inverter. Moreover, the end point B, is located at the intersection of the current control circle Cr with the maximum reluctance torque phase line α, so the magnetic force of the stator salient pole 24 at the Q position in FIG. 5 at the current phase at which the reluctance torque is maximum is maximized in the allowable current range, and it is possible to further increase the rotor torque.

FIG. 4 shows the rotor torque corresponding to the d-axis current Id and the q-axis current Iq at the lower side. In FIG. 4, the dashed lines IdC, IqC, TrC are in the case of the comparative embodiment. In the comparative embodiment, as indicated by the dashed-line arrow R in FIG. 3, the current vector is changed such that the current locus of the current vector extends from the end point A to the end point C in a straight line and then returns from the end point C to the end point A in a straight line. In the above comparative embodiment, the d-axis current Id increases at the time when the current vector is changed from A to B; however, the rotor currents steeply reduce to 0 so as to cancel the increase in the d-axis current Id. In addition, in the comparative embodiment, a generated reluctance torque at the time when the current pulses are being superimposed is small or 0. In the above comparative embodiment, an amount of reduction in torque at the time when the current pulses are being superimposed increases. On the other hand, according to the present embodiment, the d-axis current Id at the time when the current pulses are being superimposed increases; however, the reluctance torque in the case where the rotor currents reduce at the time when the current vector is changed from A to B increases, so it is possible to reduce the amount of reduction in rotor torque as indicated by a shaded area β1. In addition, when the rotor currents are increased at the time when the current vector is changed from C to A, it is possible to increase the rotor torque through an increase in reluctance torque as compared to the comparative embodiment as indicated by a shaded area β2.

In the rotary electric machine 12, the frequency of magnetic flux fluctuations in magnetic fluxes that link with the rotor coils 32n, 32s increases with an increase in rotation speed, and, as a result, the rotor coil currents increase, and the rotor torque increases; however, in FIG. 4, improvement in rotor torque due to the frequency of magnetic flux fluctuations is not taken into consideration, and only the rotor torque that is generated by superimposing the current pulses is shown. In other words, when no current pulse is superimposed, the rotor torque in FIG. 4 remains 0. Actually, the rotor torque temporally considerably gently and gradually reduces due to a direct-current resistance component of the rotor coils in a period of time Ta in which no pulse is superimposed; however, it is possible to recover the rotor torque in the second half of superimposition of the current pulses by repeatedly superimposing the current pulses on the d-axis current Id and the q-axis current Iq.

If the first predetermined period of time T1 at the time when the current vector is changed between the first current vector I₁ and the intermediate current vector Im is set so as to be shorter than or equal to the second predetermined period of time T2 at the time when the current vector is changed between the intermediate current vector Im and the second current vector I₂, in the case where the width of variation in the d-axis current Id between point A and point B is set so as to be larger than the width of variation in Id between point B and point C, it is possible to steeply change the d-axis current Id between point A and point B, and it is possible to reduce torque.

The end point B of the intermediate current vector Im is set at the intersection of the current control circle Cr with the maximum reluctance torque phase line α. However, the end point B may be set on the current control circle Cr other than the intersection. In addition, the end point B may be set inside the current control circle Cr and in an outer region AO that is the shaded area in FIG. 3, located on the opposite side of the line AC with respect to the origin point O. The line AC is the imaginary vector locus that connects point A and point C and that passes through the end point of the imaginary current vector Ima. For example, the end point B may be set at any one of point B1, point B2 and point B3 in FIG. 3. When the end point B is set at point B1, the vector locus varies among point A, point B1 and point C, and passes through the outer region AO even on the maximum reluctance torque phase line α. Therefore, in comparison with the comparative embodiment, it is possible to improve the rotor torque through an increase in reluctance torque. The same applies to the case where the end point B is set at point B2 or point B3.

The current vector may be changed to the intermediate current vector Im only one of the time when the current vector changes from the first current vector I₁ to the second current vector I₂ and the time when the current vector changes from the second current vector I₂ to the first current vector I₁. In this case as well, it is possible to improve the rotor torque when the current vector is changed to the intermediate current vector Im.

The control device 46 may superimpose the current pulses on the d-axis current command value Id and the q-axis current command value Iq only at or below a predetermined rotation speed of the rotary electric machine 12.

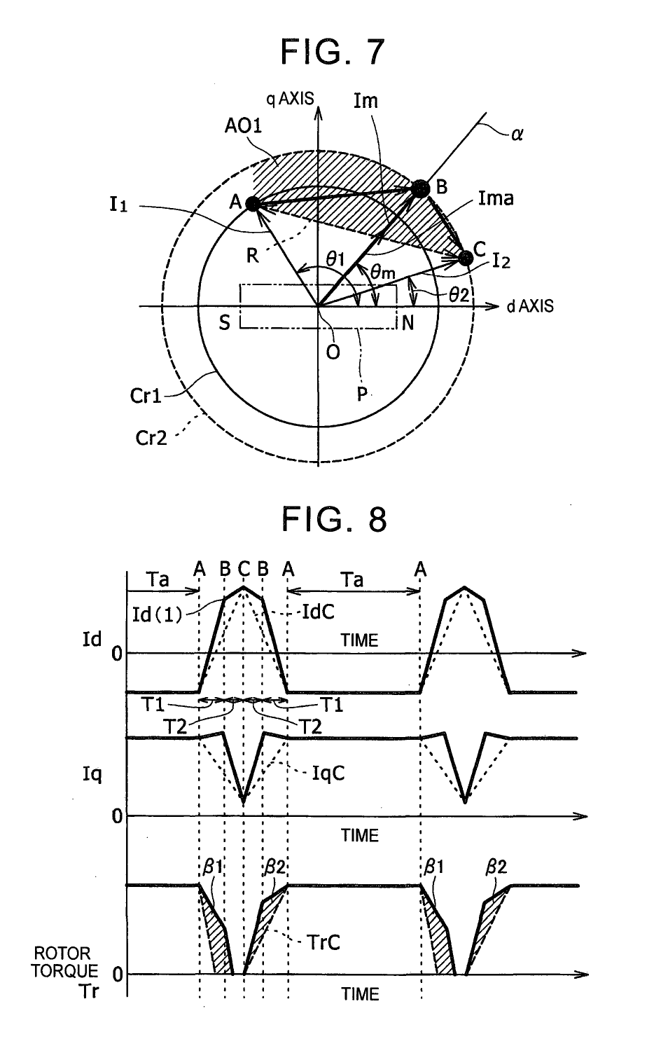

FIG. 7 is a graph corresponding to FIG. 3 in an alternative embodiment of the invention. FIG. 8 is a time chart corresponding to FIG. 4. The present alternative embodiment differs from the above-described embodiment shown in FIG. 1 to FIG. 6 in that the Id-Iq pulse generating unit 48 shown in FIG. 2 sets a continuous energization permission control circle Cr1 that is a first current control circle and an instantaneous energization permission control circle Cr2 that is a second current control circle and is larger than the continuous energization permission control circle Cr1 and sets a current vector on which current pulses have not been superimposed yet and a current vector at the time when the current pulses are being superimposed in the d-q coordinate system.

In this case, the end point A of the first current vector I₁ is set on the continuous energization permission control circle Cr1, and the end point C of the second current vector I₂ is set on the instantaneous energization permission control circle Cr2. In addition, the end point B of the intermediate current vector Im is set on the instantaneous energization permission control circle Cr2 at the intersection of the instantaneous energization permission control circle Cr2 with the maximum reluctance torque phase line α at the intermediate phase θm at which the reluctance torque is maximum. Therefore, the intermediate current vector Im has a current phase of 45° at which the reluctance torque is maximum.

The end point of the current vector starts from point A at the time when superimposition of the current pulses is started, reaches point B after a lapse of the preset first predetermined period of time T1, reaches point C after a lapse of the second predetermined period of time T2, and sequentially returns to point B in the same second predetermined period of time T2 and then to point A in the same first predetermined period of time T1 With such a configuration as well, the intermediate current vector Im on the maximum reluctance torque phase line α is larger than the imaginary current vector Ima, so it is possible to increase the reluctance torque, and it is possible to improve the rotor torque at the time when the current pulses are being superimposed. Moreover, the instantaneous energization permission control circle Cr2 is set outside the continuous energization permission control circle Cr1, and the end points B, C of the current vectors Im, I₂ at the time when the pulses are superimposed are set on the instantaneous energization permission control circle Cr2. The instantaneous energization permission control circle Cr2 defines the maximum allowable current range in short-time energization in order to protect the component, such as the inverter, and may be set so as to be larger than the current control circle Cr shown in FIG. 3. Therefore, the intermediate current vector Im and the second current vector I₂ may be set so as to be larger than the first current vector I₁, and the rotor torque at the time when the pulses are being superimposed may be set so as to be larger than that in the case of the configuration shown in FIG. 1 to FIG. 6. With the configuration shown in FIG. 7 and FIG. 8 as well, it is possible to suppress an excessive increase in stator currents at the time when the current pulses are superimposed.

The end point B of the intermediate current vector Im is set at the intersection of the instantaneous energization permission control circle Cr2 with the maximum reluctance torque phase line α. However, the end point B may be set on the instantaneous energization permission control circle Cr2 other than the intersection. In addition, the end point B may be set inside the instantaneous energization permission control circle Cr2 and in a region AO1 that is located on the opposite side of the line AC with respect to the origin point O. The line AC is the imaginary vector locus that changes in a straight line from the first current vector I₁ to the second current vector I₂. The d-axis current in the region AO1 is larger than the d-axis current of the first current vector I₁. The other configuration and function are similar to those in the case of FIG. 1 to FIG. 6.

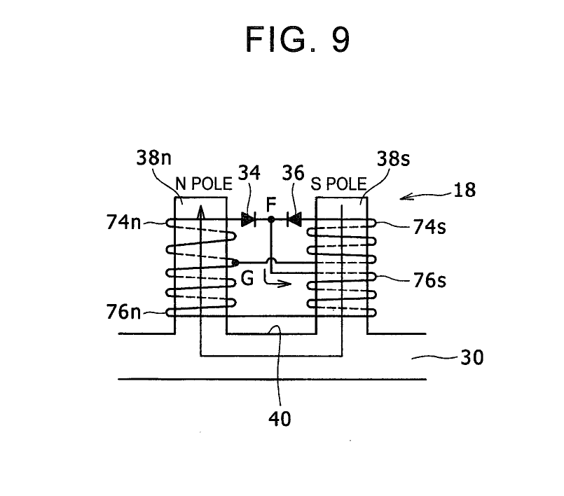

In the above-described embodiments, the description is made on the case where the rotor coil is wound around each of the rotor salient poles 38n, 38s of the rotary electric machine 12 one by one; instead, the embodiments may be applied to control over a rotary electric machine having the arrangement configuration of the rotor coils shown in FIG. 9. FIG. 9 partially shows the rotor 18 in the circumferential direction and the diodes 34, 36 are connected to rotor coils 74n, 74s, 76n, 76s in an alternative embodiment of the rotary electric machine. The rotor coil 74n is wound around the radially outer distal end side of the rotor salient pole 38n as an induction coil, and the rotor coil 74s is similarly wound around the rotor salient pole 38s.

The rotor coil 76n is wound around the radially inner proximal end side of the rotor salient pole 38n as a common coil, and the rotor coil 76s is similarly wound around the rotor salient pole 38s. One end of the rotor coil 74n is connected to one end of the rotor coil 74s via the first diode 34 and the second diode 36. Both diodes 34, 36 are connected at a connection node F such that the mutually forward directions are oriented in opposite directions.

One end of the rotor coil 76s is connected to the connection node F, and the other end of the rotor coil 76s is connected to one end of the rotor coil 76n. The other end of the rotor coil 76n is connected to the other ends of two rotor coils 74n, 74s at a connection node G.

With this configuration as well, magnetic fluxes link with the rotor coils 74n, 74s from the stator side and rotor coil currents flow, so N pole is formed at the distal end of the rotor salient pole 38n, and S pole is formed at the distal end of the rotor salient pole 38s. In the rotor, all the N-pole rotor coils 74n may be serially connected to be handled as a single N-pole serially connected induction coil, and all the S-pole rotor coils 74s may be serially connected to be handled as a single S-pole serially connected induction coil. In this case, all the N-pole rotor coils 76n are serially connected to be handled as a single N-pole serially connected common coil, and all the S-pole rotor coils 76s are serially connected to be handled as a single S-pole serially connected common coil. On that basis, the two diodes may be shared in the rotor as a whole using the connection relationship shown in FIG. 9.

The embodiments of the invention are described above; however, the invention is not limited to the above embodiments. The invention may be, of course, implemented in various forms without departing from the scope of the invention. For example, the description is made on the case where the stator coils are wound in the stator by concentrated winding; instead, as long as it is possible to generate a revolving magnetic field including harmonic components in a stator, stator coils may be wound in the stator by distributed winding.

1. A rotary electric machine control system comprising:
a rotary electric machine including
a stator configured to generate a revolving magnetic field;
a rotor arranged so as to face the stator, the rotor having rotor coils wound around rotor cores through slots, the slots being formed on the rotor, the rotor having rectifying units connected to the corresponding rotor coils and each configured to rectify a rotor coil current in a selected one direction, and the rotor having rotor salient poles that have alternately different polarities in a circumferential direction due to the rotor coil currents; and
a control device configured to superimpose current pulses on a current vector that generates the revolving magnetic field,
the control device being configured to set a first current vector on which the current pulses have not been superimposed yet and a second current vector obtained by increasing a d-axis current by a predetermined amount of increase and reducing a q-axis current by a predetermined amount of reduction from the first current vector,
the control device being configured to, where a phase between the current vector and a d-axis positive direction is defined as a current phase, set an intermediate current vector when there is a current phase at which a reluctance torque is maximum between a first current phase of the first current vector and a second current phase of the second current vector, the intermediate current vector having an intermediate phase between the first current phase and the second current phase and being larger than an imaginary current vector in the case where a vector locus is varied in a straight line from the first current vector to the second current vector,
the control device being configured to change the current vector from the first current vector to the second current vector and further change the current vector from the second current vector to the first current vector, and
the control device being configured to generate the current pulses by changing the current vector to the intermediate current vector in at least one of the time when the current vector is being changed from the first current vector to the second current vector and the time when the current vector is being changed from the second current vector to the first current vector.

2. The rotary electric machine control system according to claim 1, wherein the control device is configured to set an end point of the first current vector and an end point of the second current vector on a common current control circle, and
the control device is configured to set an end point of the intermediate current vector in a region surrounded by the current control circle and an imaginary vector locus that varies in a straight line from the first current vector to the second current vector, the region including the current control circle other than the end point of the first current vector and the end point of the second current vector.

3. The rotary electric machine control system according to claim 2, wherein the intermediate current vector has the current phase at which the reluctance torque is maximum, and the control device is configured to set the end point of the intermediate current vector on the current control circle.

4. The rotary electric machine control system according to claim 1, wherein the control device is configured to set an end point of the first current vector on a first current control circle,
the control device is configured to set an end point of the second current vector on a second current control circle larger than the first current control circle, and
the control device is configured to set an end point of the intermediate current vector in a region surrounded by an imaginary vector locus that varies in a straight line from the first current vector to the second current vector, the second current control circle, and a line that connects the end point of the first current vector to a point on the second current control circle located on a q-axis positive direction side with respect to the end point of the first current vector, the region including the second current control circle.

5. The rotary electric machine control system according to claim 4, wherein the intermediate current vector has the current phase at which the reluctance torque is maximum, and the control device is configured to set the end point of the intermediate current vector on the second current control circle.

6. A control method for a rotary electric machine, the rotary electric machine including
a stator configured to generate a revolving magnetic field; and
a rotor arranged so as to face the stator, the rotor having rotor coils wound around rotor cores through rotor slots, the slots being formed on the rotor, the rotor having rectifying units connected to the corresponding rotor coils and each configured to rectify a rotor coil current in a selected one direction, and the rotor having rotor salient poles that have alternately different polarities in a circumferential direction due to the rotor coil currents; and
a control device,
the control method comprising:
superimposing, by the control device, current pulses on a current vector that generates the revolving magnetic field;
setting, by the control device, a first current vector on which the current pulses have not been superimposed yet and a second current vector obtained by increasing a d-axis current by a predetermined amount of increase and reducing a q-axis current by a predetermined amount of reduction from the first current vector;
where a phase between the current vector and a d-axis positive direction is defined as a current phase, setting an intermediate current vector when there is a current phase at which a reluctance torque is maximum between a first current phase of the first current vector and a second current phase of the second current vector, the intermediate current vector having an intermediate phase between the first current phase and the second current phase and being larger than an imaginary current vector in the case where a vector locus is varied in a straight line from the first current vector to the second current vector;
changing, by the control device, the current vector from the first current vector to the second current vector and further changing the current vector from the second current vector to the first current vector; and
generating, by the control device, the current pulses by changing the current vector to the intermediate current vector in at least one of the time when the current vector is being changed from the first current vector to the second current vector and the time when the current vector is being changed from the second current vector to the first current vector.
